(19) United States
(12) Patent Application Publication
(10) Pub. No.: US 2002/0156635 A1
(43) Pub. Date: Oct. 24, 2002

(54) Automatic information system

(76) Inventor: Lenke Nils, Rheinbach (DE)

Correspondence Address: U.S. Philips Corporation, 580 White Plains Road, Tarrytown, NY, 10591, US

(21) Appl. No.: 10/117,810

(22) Filed: Apr. 8, 2002

(30) Foreign Application Priority Data
Apr. 11, 2001 (DE) 10118125.6

(51) Int. Cl. G10L 21/00

(52) U.S. Cl. 704/270.1

(57) ABSTRACT

An automatic information system is described which is connected for use to a user terminal. The automatic information system comprises a database (1), in which are stored subscriber data (TD) from a plurality of subscribers. At least part of the subscriber data (TD) in each case comprises the network address of a communication unit of the respective subscriber within a data network, In addition, the automatic information system comprises a search means (3) for searching for the desired subscriber on the basis of search parameters obtained from the user and a user dialog system (2) for control of the automatic information system by the user and/or for outputting to the user prompts and/or subscriber data (TD) relating to a subscriber found in the database (1). The user dialog system (2) comprises automatic speech recognition and an acoustic output device. In addition, a method is claimed for operating such an automatic information system.

The invention relates to an automatic information system, which is connected for use to a user terminal, having a database in which subscriber data from a plurality of subscribers are stored, wherein at least part of the subscriber data in each case comprises the network address of a communication unit of the respective subscriber within a data network, having a search means for searching for the desired subscriber on the basis of the subscriber data stored in the database using search parameters obtained from the user and having a user dialog system for control of the automatic information system by the user and/or for outputting to the user prompts and/or subscriber data relating to the found subscriber. The invention additionally relates to a method of operating such an automatic information system.

A long-known information service is Directory Enquiries, which may be called by means of a normal landline telephone, a cell phone or indeed by means of other terminals with an appropriate telephone function, in order to obtain therefrom the telephone number of another subscriber. To this end, the subscriber data, such as names, addresses and telephone numbers or fax numbers are stored in an information service database and the respective user of the information specifies particular search parameters by means of which a search may then be performed in the database for the desired subscriber. The search parameters comprise the search criteria such as, for example, name, place of residence, dialing code or trade or specialism etc. together with the associated search words, e.g. “Meier”, “Cathedral Street”, “Munich”, “Dentist”. With telephone information services, a distinction is drawn between trade information, in which a trade and a place may be input and a number of people working in this trade may optionally be output to the user (so-called “Yellow Pages” service), and trade-independent information, where inquiries relate to specific subscribers (so-called “White Pages” or “Pink Pages”). In addition, automatic information systems are already known in data networks, for example the Internet or larger Intranets. These information systems function automatically via a user dialog system, in which the respective user transmits control commands to the automatic information system via his/her terminal, for example a PC connected to the Internet, and the search parameters are requested by the user dialog system of the automatic information system and the subscriber data relating to the found subscriber are output to the user. These systems consequently comprise a search means, which, activated by means of the user dialog system, searches for the desired subscriber or the subscribers in a particular trade on the basis of the subscriber data stored in the database using the search parameters. In contrast to the currently conventional Directory Enquiries services, some databases which may be accessed via the Internet already contain the network addresses of some subscribers' communication units operating within a data network. The communication unit may comprise, for example, the subscriber's Internet mailbox or Web page. Such user-friendly automatic information systems with extensive databases which include not only telephone numbers but also addresses which allow the respective subscriber to be contacted via other networks than a telephone network have, however, hitherto been accessible only via PCs or by means of special terminals with appropriate Internet access capability, for example so-called WAP phones. Placing an inquiry via a normal telephone is unfortunately not an option.

It is an object of the present invention to provide a user-friendly, extensive, automatically operated information system and a method of operating such an information system, which may be used from any terminals, in particular normal telephones.

Said object is achieved by an automatic information system as claimed in claim 1 and a method as claimed in claim 8.

According to the invention, the user dialog system is provided with an automatic speech recognition device, which receives and recognizes the voice commands and/or search parameters sent by the user via the terminal, together with a voice output device. The voice output device puts the user dialog system in a position for example of being able to output spoken prompts via a normal telephone and thus to request the search parameters or even to output the subscriber data relating to the found subscriber to the user.

The voice output device comprises a speech synthesis device, for example, which composes a desired word or a desired sentence from spoken portions of text. However, it may also additionally or alternatively contain a database with sound files containing prespoken text, which is transmitted to the user by the user dialog system at the appropriate time when activated accordingly.

In addition to speech, the voice output device may preferably also emit start signals, to signal to a user that a control command or a search parameter should now be input, for example, or audible acknowledgement signals, which acknowledge recognition of the input command or search parameter. The term “voice output” is intended to include this possibility. In addition to the automatic speech recognition device, the user dialog system preferably also comprises means for receiving and processing control commands via the pushbuttons of a telephone, for example the DTMF (Dual Tone Multi Frequency) pushbuttons usual with modern telephones.

Due to this user dialog system, which is in a position to communicate with the respective user purely acoustically, the information system may be used from any normal telephone or indeed from a PC or other terminals with a microphone, a loudspeaker and a telephone connection, i.e. without any special data connection. This information system has the advantage over the known user-friendly Internet information systems of being independent of special equipment and Internet connection options, the field of use thus not being limited to instances where appropriate Internet access possibilities exist. Moreover, this information system also has advantages for blind people, who are instructed in the use of an acoustically operating user dialog system.

In a preferred example of embodiment of the invention, the email addresses of the mailboxes of the respective subscribers are stored in the database as network addresses. Alternatively or in addition thereto, the URL (Uniform Resource Locator) of a defined Internet page, a so-called Web page, may also be entered as a network address. For the purposes of this document, the term Web page should moreover be viewed as having its broadest meaning. It is intended, inter alia, to cover both the generally known HTML pages and also VoiceXML or V-XML pages or the like.

In a particularly preferred example of embodiment, the system additionally comprises a voice interface for producing a communication connection with the communication unit exhibiting the network address of the found subscriber. That is to say, a connection is produced with the communication unit on the network via the voice interface via an appropriate network connection unit (gateway). This is preferably performed at the wish of the user, for example through input of an appropriate control command, after the respective network address has been given to the user and the latter has optionally been asked whether a connection is desirable.

This communication connection may be so designed as to be able merely to send a message. However, the communication connection may be bi-directional, allowing true communication with the communication unit on the network, i.e. both messages and control signals are sent to the communication unit and information may be retrieved.

In one embodiment, the voice interface comprises means for sending a simple voice message, for example a so-called voicemail, to the mailbox of a found subscriber. There are various possible ways of sending such a voice message to the mailbox of the found subscriber. On the one hand, the voice interface may record the voice message in a sound file and produce an accompanying email containing the sound file as an attachment. This accompanying email contains the necessary data and has the appropriate format for sending the accompanying email with attached sound file to the desired email address. In such a case, a voice message may inter alia also contain other sounds, a piece of music or the like. In this respect, the term voice message should be viewed as having its broadest meaning. The accompanying email may be an email with a standard text, such as for example “Please open the attached sound file” or the like.

In an alternative example of embodiment, the voice message is converted directly into a text message within a suitable email. That is to say, to all intents and purposes an email is dictated or the voice message is converted into an email format. This email is then sent to the desired email address. In this case, the voice interface requires a speech recognition device.

The system may also be so designed that voice messages may be sent as desired in one or other of the ways mentioned.

In a further preferred embodiment, the voice interface comprises as “voice portal” a voice-activated browser, a so-called voice browser, with which a subscriber's Web page with the found URL as portal site may be called up. Starting at the portal site, the voice browser may be used to surf the Internet, by activating particular links on the current Web page by voice commands and thereby calling up another Web page.

By means of such a voice portal, it is possible on the one hand to call up specially prepared Internet pages which are designed for voice communication, such as VoiceXML or V-XML pages for example. In principle, however, it is also possible to call up “normal” HTML pages, provided that the voice browser is in a position, due to a suitable speech recognition device and a suitable voice output device, for example a speech synthesis device, to convert the information on the Internet page into speech and conversely to convert speech data from the user into commands required by the HTML Internet page.

A particularly extensive, user-friendly automatic information system offers the possibility both of sending voice messages to email addresses and of calling up Internet pages via a voice browser.

The invention will be further described with reference to examples of embodiment shown in the drawings to which, however, the invention is not restricted. The features explained below and the features already described above may be essential to the invention not only in the above-mentioned combinations but also individually or in different combinations. The invention is described in this specification partly using relatively broad process sequences and steps together with generally known terms such as “call up” (a Web page), “surfing” (a network) or “send” (an email) etc. The representations given of operations within computer memories or computer networks are those conventionally used by the person skilled in the art in these fields. It should not be forgotten that these are steps which require physical influences produced by physical variables. These variables usually take the form of electrical or magnetic signals, which are in a position to be stored, transmitted, combined, compared or otherwise manipulated as in a computer system.

In the Figures:

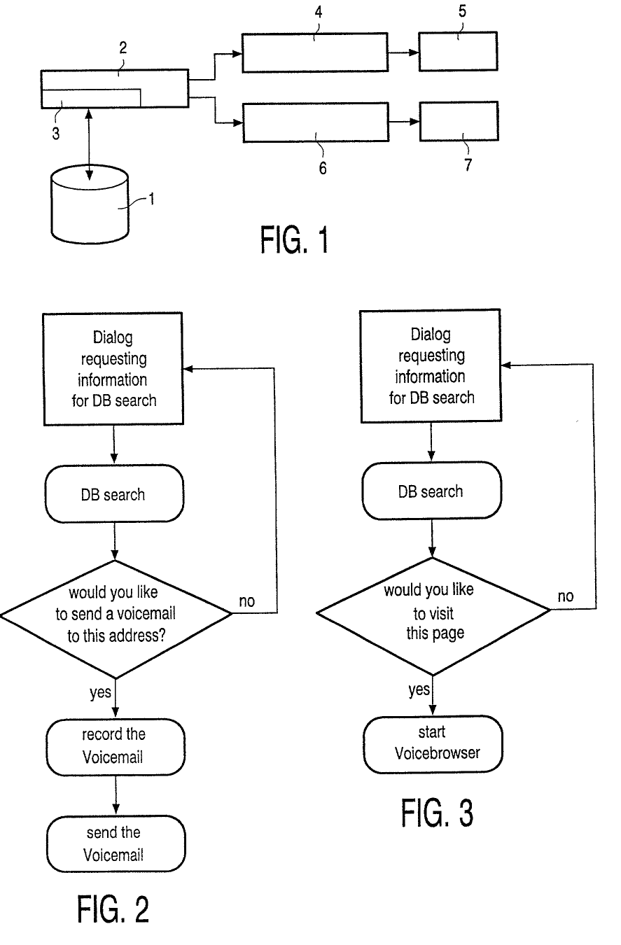

FIG. 1 is a schematic representation of the architecture of an automatic information system according to the invention.

FIG. 2 shows a simple dialog flow within a dialog system of the information system according to the invention for sending a voicemail.

FIG. 3 shows a simple dialog flow in a dialog system of an information system according to the invention for calling up a Web page.

The automatic information system shown in FIG. 1 allows both sending of a voice mail to the email address of a found subscriber and opening of a Web page belonging to a found subscriber. An essential component of this automatic information system is a database 1, in which are stored subscriber data TD from various subscribers, for example telephone subscribers and/or subscribers with an Internet connection and corresponding addresses. These subscriber data consequently comprise not only the names, physical addresses and telephone and fax numbers of the respective subscribers, but also, where available, all known network addresses for the widest possible range of communication units used by the subscriber within a data network, i.e. for example email addresses and URLs of any Internet Web pages.

In addition to the database 1, the information system comprises a search means 3 for searching for the desired subscriber on the basis of the subscriber data TD stored in the database 1 using search parameters obtained from the user. Such a search means is installed in the form of software on a suitable computer, for example a server connected to the Internet and/or to a telephone network.

In order to enter into communication with the respective user, the information system comprises a user dialog system 2. According to the invention, this user dialog system 2 allows a completely automatic speech dialog with the user, since it comprises automatic speech recognition and a voice output device, for example a speech synthesis device. This user dialog system 2 makes it possible for the user to control the automatic information system as desired in accordance with preset menu prompting and to input the desired search parameters and receive the output subscriber data. This user dialog system thus forms the information system communication interface for the respective user. Since the dialog system operates acoustically, communication is possible by means of any desired terminal comprising a voice input and output device.

The information system according to FIG. 1 further comprises a voice interface 4 for sending a voice message, e.g. a voicemail. Furthermore, the information system comprises a voice interface 6 or voice portal 6 with a voice browser, with which an Internet Web page may be called up.

By means of the first voice interface 4, a voice message is recorded in a sound file and attached to a standard email. This email is then forwarded by the voice interface 4 to an email gateway 5, which sends the email to an email address found in the database 1 by the search means 3 as belonging to the subscriber searched for.

The second voice interface 6 with the voice browser serves to allow the user to call up specific Internet Web pages or even to surf the Internet via a subsequent Internet gateway 7 by voice using a terminal.

The voice interface 4 for sending the voice message via email or the voice interface 6 with the voice browser and the respectively associated gateways 5, 7 may be a direct component of the information system, i.e. installed for example on the same server in the form of software, or even implemented together with the dialog system 2 and the search means 3 in the manner of software as subroutines of a suitable program. However, parts of the system may also be constructed as hardware. In this respect, the automatic speech recognition device and/or the voice output device are preferably so designed that both the user dialog system 2 and the two voice interfaces 4 and 6 use these components or may access these components.

Alternatively, the voice interface 4 for sending the voice message and the voice portal 6 with its associated components may however also be spatially separated from the actual information system itself. These components are then appropriately called up by the user dialog system 2 or the user is transferred to the appropriate components 4, 6. Transfer may also take place for example during Internet surfing by means of the voice portal 6, this being transparent to the user.

FIG. 2 shows a simple procedure within the user dialog system 2 according to FIG. 1, if a voicemail is to be sent. The user begins with a dialog requesting the information required for the database search. Once all the information has been requested of the user, i.e. all the search parameters are known to the information system, the database search begins, wherein this database search may also be carried out with the user dialog system 2 in constant use for requesting additional information, e.g. more specific search parameters, and for outputting intermediate results. If the email address is found for a desired subscriber, the user is asked via the user dialog system 2 whether he/she would like to send a voicemail to this address. If the user says no, the system returns to the output state and asks, for example, whether the user would like further information. If, on the other hand, the user says yes, he/she is transferred to the voice interface 4. There, a voicemail is recorded and attached to a standard email generated specially for this purpose. The voicemail is then sent via the Internet gateway 5 as an attachment to the standard email generated.

FIG. 3 shows a very similar, simple flow chart within the user dialog system 2 for an instance in which the URL of a Web page belonging to the desired subscriber is found. Here too, the first step is the dialog requesting the information required for a database search. The database search is then performed and, as soon as a Web page URL is found, the user is asked whether he/she would like to visit this page. If the user says no, he/she is returned to the user dialog system. The user is then given the opportunity of requesting further information. If, on the other hand, he/she answers yes to the question, the user is automatically transferred to the voice portal 6 and the voice browser is thus started, in order to call up the Web page with the found URL via the Internet gateway 7.

The information system according to the invention is of particular interest to companies who wish to publicize to potential customers through the information system not only their address and telephone and fax numbers but also their email address and the address of the Homepage constituting the respective company's presence on the Internet, and also wish to provide these customers with the immediate opportunity of retrieving further information about the company.

1. An automatic information system, which is connected for use to a user terminal, having
a database (1) in which subscriber data (TD) from a plurality of subscribers are stored, at least part of the subscriber data (TD) in each case comprising the network address of a communication unit of the respective subscriber within a data network,
a search means (3) for searching for the desired subscriber on the basis of the subscriber data (TD) stored in the database (1) using search parameters obtained from the user,
and having a user dialog system (2) for control of the automatic information system by the user and/or for outputting to the user prompts and/or subscriber data (TD) relating to the found subscriber, characterized in that the user dialog system (2) comprises automatic speech recognition and a voice output device.

2. A system as claimed in claim 1, characterized in that the network address comprises an email address of a mailbox and/or a URL of a Web page belonging to the respective subscriber.

3. A system as claimed in claim 1 or claim 2, characterized by a voice interface (4, 6) for producing a communication connection with a communication unit exhibiting the network address of a found subscriber.

4. A system as claimed in claim 3, characterized in that the voice interface (4) comprises means of sending a voice message to a subscriber's mailbox.

5. A system as claimed in claim 4, characterized in that the voice interface (4) comprises means of recording the voice message in a sound file and means of producing an accompanying email, containing the sound file as an attachment.

6. A system as claimed in claim 4 or claim 5, characterized in that the voice interface comprises means of converting the voice message into a text message within an email.

7. A system as claimed in one of claims 3 to 6, characterized in that the voice interface (6) comprises a voice-activated browser for calling up a subscriber's Web page.

8. A method of operating an automatic information system, in which a search is carried out on the basis of search parameters, which are transmitted to the system by means of a user terminal via a user dialog system (2), for subscribers whose subscriber data (TD) stored in a system database (1) match the search parameters, and in which the subscriber data (TD) relating to at least one found subscriber are output to the user via the user dialog system (2), at least part of the subscriber data (TD) in each case comprising the network address of a communication unit of the respective subscriber within a data network, characterized in that the user dialog system (2) accepts and recognizes by means of an automatic speech recognition device voice commands and/or search parameters transmitted to the information system by the user and outputs prompts and/or the subscriber data (TD) by means of a voice output device.

9. A method as claimed in claim 8, characterized in that email addresses of mailboxes and/or URLs of Web pages belonging to the subscribers are stored in the database (2) and output to a user as subscriber data (TD).

10. A method as claimed in claim 8 or claim 9, characterized in that a communication connection with a communication unit exhibiting the network address of a found subscriber is produced by means of a voice interface (4, 6).

11. A method as claimed in claim 10, characterized in that, by means of the voice interface (4), a voice message is sent to the subscriber's mailbox.

12. A method as claimed in claim 11, characterized in that the voice message is recorded in a sound file and an accompanying email is produced which contains the sound file as an attachment, and this accompanying email is sent with the attached sound file to the subscriber's mailbox.

13. A method as claimed in claim 11 or claim 12, characterized in that the voice message is converted into a text message within an email.

14. A method as claimed in one of claims 10 to 13, characterized in that a subscriber's Web page is called up as an Internet portal site by means of a voice-activated browser.
